(19) United States
(12) Patent Application Publication
(10) Pub. No.: US 2014/0331202 A1
(43) Pub. Date: Nov. 6, 2014

(54) Software Analysis Program and Software Analysis System

(71) Applicants: Takeshi Fukuda, Tokyo (JP); Yoshitaka Atarashi, Tokyo (JP); Kentaro Yoshimura, Tokyo (JP); Keiichi Aida, Tokyo (JP); Yohei Sugiyama, Tokyo (JP)

(72) Inventors: Takeshi Fukuda, Tokyo (JP); Yoshitaka Atarashi, Tokyo (JP); Kentaro Yoshimura, Tokyo (JP); Keiichi Aida, Tokyo (JP); Yohei Sugiyama, Tokyo (JP)

(73) Assignee: Hitachi, Ltd., Chiyoda-ku, Tokyo (JP)

(21) Appl. No.: 14/364,502

(22) PCT Filed: Dec. 12, 2011
(86) PCT No.: PCT/JP2011/006908

§ 371 Date: Jun. 11, 2014

(51) Int. Cl. G06F 9/44

(52) U.S. Cl. CPC G06F 8/75
USPC 717/123

(57) ABSTRACT

To easily specify a difference part among multiple source codes even in the case of software that is relatively large scaled and complicated as an embedded system, and to make it possible for an area of influence that the difference part has to be easily understood. In a software analysis system of an embedded system into which a computer system is embedded, the software analysis system has a similarity measurement part that treats a dependence relationship in the source code controlling the embedded system as a graphical structure and measures a similarity of one or more source codes, and an image display unit for displaying the similarity.

### TECHNICAL FIELD

The present invention relates to a software analysis program suitable for development, verification, and maintenance support of software, and a software analysis system that uses this program.

### BACKGROUND ART

In technical fields of elevators, vehicles, construction machinery, etc., an embedded control device for controlling a control object with so-called embedded software is used. Regarding the embedded software, there are enumerated points as its advantages that it can realize a soft and advanced control as compared with conventional methods based on a mechanical mechanism and an electric circuit, and a large number of derivative products can be developed by partial alteration of the software, and the like.

In recent years, control processing that is required in the embedded control devices become more complicated year by year and a dependence relationship between control variables becomes complicated, which makes it difficult to develop the software. On the other hand, a software development cycle is required to be shortened. In contrast to this, in order to develop complicated and large-sized software in a short time, derivational development that reuses existing software as efficiently as possible becomes important.

In the derivational development that reuses the existing software, a difference part between an existing product and a new product is subjected to change development or new development. During doing this, in developing complicated software in a short time, it is an indispensable technology to understand the difference part between the existing product and the new product efficiently.

As a technology of specifying the difference part of software, a technology of specifying a change part by contrasting two source codes is known and, for example, is described in Patent Literature 1.

Moreover, on the other hand, in order to understand a structure of a present source code efficiently, there is known a technology that analyzes an existing source code control flow and a data dependence relationship and displays an application structure with a graph comprised of nodes and links, which is described, for example, in Patent Literature 2.

### CITATION LIST

### Patent Literature

PTL 1: Japanese Patent Application Laid-Open No. 2004-326337
PTL 2: WO2009/011056

### SUMMARY OF INVENTION

### Technical Problem

Among the above-mentioned conventional technologies, one that is described in Patent Literature 1 performs improvement of understandability of the source code that proceeds toward complication by extracting a difference between two source codes. However, for the source code that proceeds toward large-scale and complication, if only with a difference between the source codes, there are problems that it is hard to specify a change part causing a change to occur in a variable dependence relationship substantially and to specify an area of influence that the change part has on the surroundings.

Moreover, in what is described in Patent Literature 2, the variable dependence relationship of each one of source codes cannot be understood, and besides, it remains for proposing a refactoring candidate part based on complexity of an application model, and cannot make it possible to understand a different point of the two (new and old) source codes.

An object of the present invention is to solve the problems of the above-mentioned conventional technologies, and to make it possible to easily specify a difference part of one or more source codes in control software of an embedded system that is large-scaled and complicated, and no easily specify an area of influence that the difference part has on the surroundings.

### Solution to Problem

In order to solve the above-mentioned problems, the present invention is a software analysis system that analyzes multiple source codes inputted into a computer and specifies the change part of the source code, extracts a dependence relationship of a variable or a function from each of at least two source codes among multiple source codes, creates a graphical structure comprised of nodes and links, measures a similarity of the graphical structures corresponding to two respective source codes, and outputs it to the outside of the computer.

### Advantageous Effects of Invention

According to the present invention, even in the case of large-scaled and complicated software (computer program) as an embedded system, it is possible to easily specify the difference part between two pieces of software and to easily understand an area on which the difference part has an influence.

### BRIEF DESCRIPTION OF DRAWINGS

FIG. 1 is a diagram showing a display screen of a software analysis system of one embodiment according to the present invention.

FIG. 2 is a block diagram showing an entire configuration of the one embodiment according to the present invention.

FIG. 3 is a diagram showing a source code management unit in the one embodiment.

FIG. 4 is a diagram showing source code data in the one embodiment.

FIG. 5 is a flowchart showing processing of the source code management unit in the one embodiment.

FIG. 6 is a diagram showing source code version data in the one embodiment.

FIG. 7 is a diagram showing a data flow management unit in the one embodiment.

FIG. 8 is a flowchart showing processing of a source code analysis part in the one embodiment.

FIG. 9 is a diagram showing a data flow in the one embodiment.

FIG. 10 is a flowchart showing processing of a data flow registration part in the one embodiment.

FIG. 11 is a diagram showing data flow version data in the one embodiment.

FIG. 12 is a diagram showing a difference analysis unit in the one embodiment.

FIG. 13 is a flowchart showing processing of a comparison object selection part in the one embodiment.

FIG. 14 is a flowchart showing processing of a source code difference analysis part in the one embodiment.

FIG. 15 is a diagram showing a source code difference in the one embodiment.

FIG. 16 is a flowchart showing processing of a similarity measurement part in the one embodiment.

FIG. 17 is a diagram showing a similarity in the one embodiment.

FIG. 18 is a diagram showing an image display unit in the one embodiment.

FIG. 19 is a flowchart showing processing of an analysis result output part in the one embodiment.

FIG. 20 is a diagram showing display in the analysis result output part in the one embodiment.

FIG. 21 is a diagram showing the display in the analysis result output part in the one embodiment.

FIG. 22 is a diagram showing a source code version data in the one embodiment.

FIG. 23 is a diagram showing the source code difference in the one embodiment.

FIG. 24 is a diagram showing the similarity in the one embodiment.

FIG. 25 is a diagram showing the display in the analysis result output part in the one embodiment.

### DESCRIPTION OF EMBODIMENTS

The present invention relates to a software part creation support device of an embedded system in which a computer system is embedded in order to realize a specific function of a product that requires electronic control such as household appliances, industrial apparatuses, and medical equipment. This is suitable for software development, verification, and maintenance support of: a system whose necessary functions cover a lot of ground, especially, cellular phones, digital appliances, and further transportation equipment such as a vehicle, a railroad, and an elevator; and a large-scaled system in which multiple pieces of hardware and multiple pieces of software are combined.

### Example 1

Hereafter, with reference to drawings, one embodiment according to the present invention will be explained.

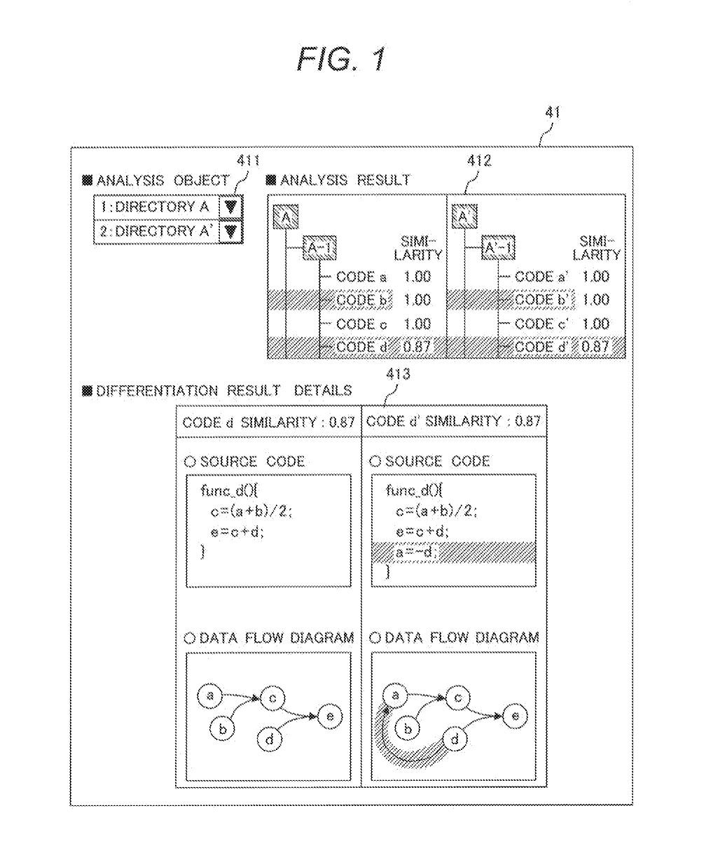

FIG. 1 is a diagram showing one example of an output screen of a software analysis system according to the present invention. Not only by designating the source code as an input and specifying a deference part of the source code, but also by interpreting a dependence relationship in the source code as a graphical structure comprised of links and nodes and measuring a similarity of the graph, not only a difference part of one or more source codes is found by the source codes but also the similarity of the graph is evaluated as an index, and an output as shown in FIG. 1 is displayed on the screen.

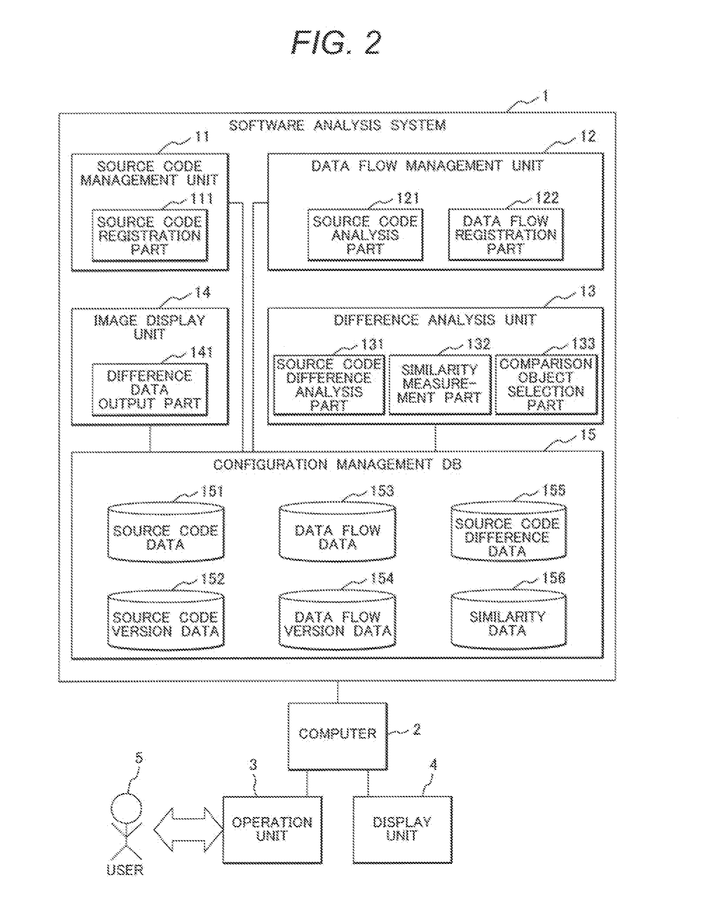

FIG. 2 is a block diagram showing a whole image of a software analysis system 1. The software analysis system has: a program that includes a source code management unit 11, a data flow management unit 12, a difference analysis unit 13, and an image display unit 14; and a configuration management. DB (Data Base) 15 for storing data that is inputted and outputted when this program is processed by a computer. The source code management unit 11 inputs therein the source code data 151 from the configuration management DB 15 as an input, and outputs source code version data 152 for performing version management of the source code. The data flow management unit 12 inputs therein the source code stored in the source code data 151 as an input, creates data flow data 153 that indicates the dependence relationship of the variable used in the source code, and outputs data flow version data 154. The difference analysis unit 13 inputs therein the source code version data 152, the data flow version data 154, and information that a user 5 operates to select using an operation unit 3 from a comparison object selection part 133 as its inputs, and outputs source code difference data 155 that is difference information between the source codes and similarity data 156 that is an index indicating a similarity of data flows. The image display unit 14 inputs therein the source code difference data 155 and the similarity data 156, and displays input information as an image in a display unit 4. Incidentally, the software analysis system 1 may be installed in another computer connected to a computer 2 that the user 5 uses as a terminal though a network etc or may be installed inside the computer 2.

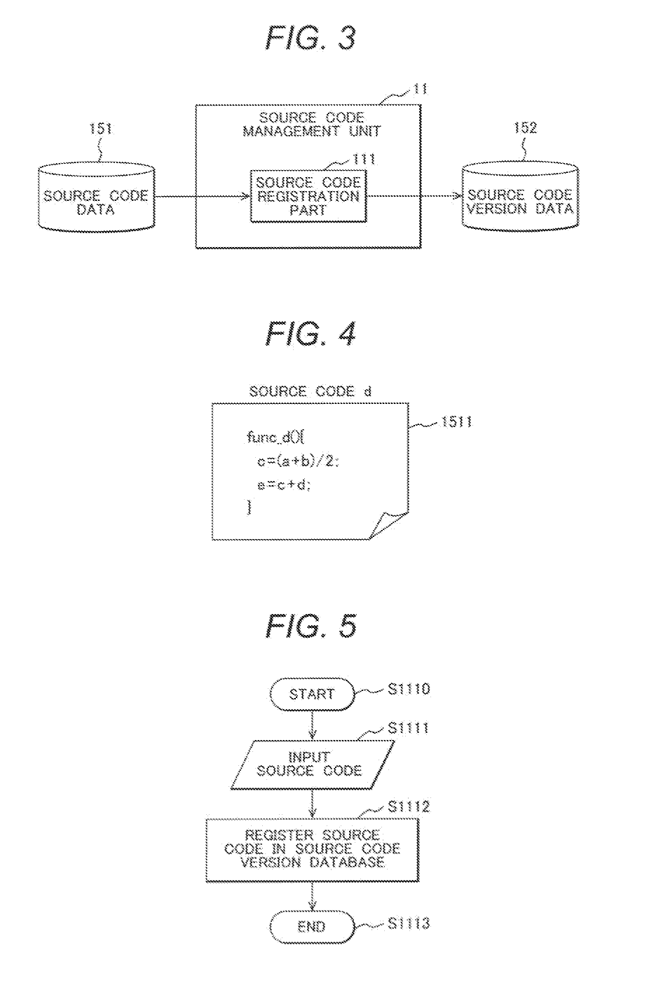

FIG. 3 is a diagram showing a detailed configuration of the source code management unit 11. The source code management unit 11 includes a source code registration part 111 that registers the source code newly stored in the source code data 151 in the source code version data 152, and the source code registration part 111 inputs therein the source code stored in the source code data 151 as an input and registers the source code data 151 in the source code version data 152 that is a database for storing multiple pieces of inputted source code data being associated with respective versions. Incidentally, the source code stored in the source code data 151 may be not only a file of the source code described in a high-level language such as C language, but may be also an object file after compilation or an execution log of a program after the compilation.

FIG. 4 is a diagram showing details of the source code data 151. A source code file 1511 is comprised of a processing procedure of a function func_d. Incidentally, variables a, b, c, d, and e used in the source code file 1511 shall be defined as global variables. In the function func_d, processing of updating the variable c from values of the variables a and b is performed, and processing of updating a variable e from values of the variables c and d is performed.

FIG. 5 is a diagram showing a detailed execution flow of the source code registration part 111. The processing begins from step S1110. At step S1111, the source code data 151 is inputted. At step S1112, the inputted source code data 151 is registered in the source code version data 152 being associated with each version. This association can be realized, for example, by acquiring a version of the source code from a file name of the source code etc. stored in the source code data 151. The processing is ended at step S1113. Thus, by registering the source code being associated with each version, selection of a comparison object by the comparison object selection part 133 being described later becomes easy.

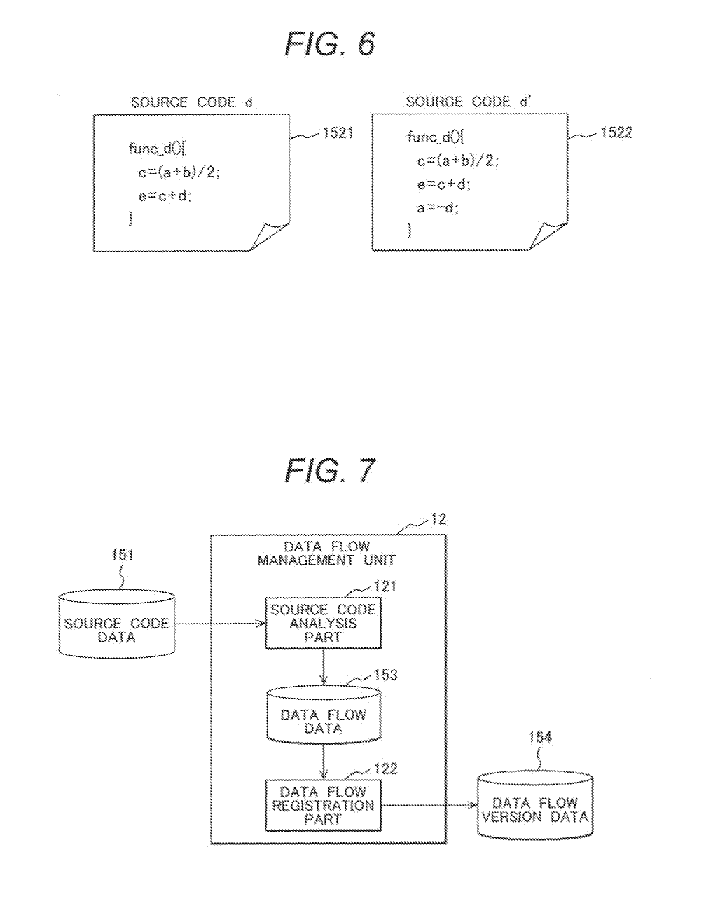

FIG. 6 is a diagram showing details of the source code version data 152. Both a source code file 1521 and a source code file 1522 show source code files with different versions that are registered in the source code version data 152, respectively. It can be seen that the source code file 1522 has an extra line in which processing of updating the variable a using a value of the variable d as compared with the source code file 1521.

FIG. 7 is a diagram showing a detailed configuration of the data flow management unit 12. The data flow management unit 12 includes a source code analysis part 121 that inputs therein the source code stored in the source code data 151, analyzes a variable dependence relationship in the source code, and creates the data flow, and a data flow registration part 122 that registers a data flow diagram in the data flow version data 154, and inputs therein the source code stored in the source code data 151, creates the data flow whose variable dependence relationship is graphed from the inputted source code file, and registers the created data flow in the data flow version data 154 that is a database for storing it being associated with each version.

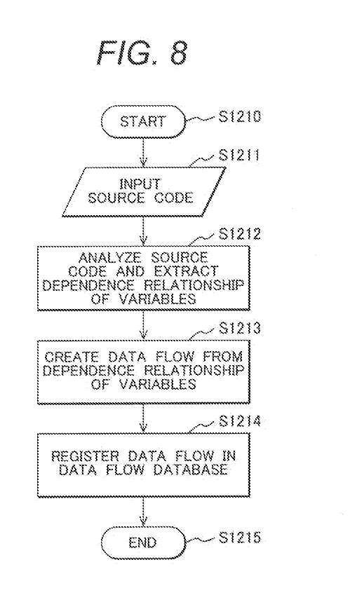

FIG. 8 is a diagram showing a detailed execution flow of the source code analysis part 121. The processing begins from step S1210. At step S1211, the source code data 151 is inputted. At step S1212, the inputted source code is analyzed and the variable dependence relationship in the source code is extracted. At step S1213, the data flow is created from the variable dependence relationship extracted at step S1212. At step S1214, the data flow created at step S1213 is registered in the data flow data 153 that is a database of the data flow. The processing is ended at step S1215.

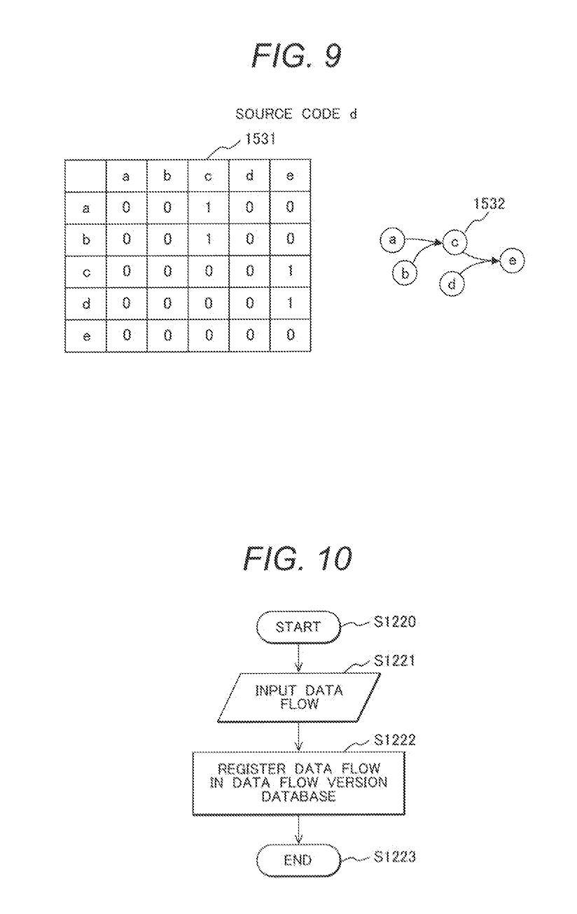

FIG. 9 is a diagram showing details of the data flow data 153. A matrix 1531 is a diagram that shows the variable dependence relationship in the source code file 1511 in tabular form. A data flow 1532 is a diagram that shows the variable dependence relationship in the source code file 1511 in graphical form. In this embodiment, the data flow 1532 shows the variable dependence relationship with a variable represented by a node and a substitution relationship between the variables represented by a link shown by an arrow. For example, here, a situation that the variable c is operated based on the variable a and the variable b is expressed with nodes representing the variables a, b, and c and links connecting these nodes.

FIG. 10 is a diagram showing a detailed execution flow of the data flow registration part 122. The processing begins from step S1220. At step S1221, the data flow is inputted from the data flow data 153. At step S1222, the data flow inputted at step S1221 is registered in the data flow version data 154 that is a version management database of the data flow, being associated with each version of the source code. The processing is ended at step S1223. Thus, by registering the data flow being associated with each version, selection of the comparison object by the comparison object selection part 133 being described later becomes easy.

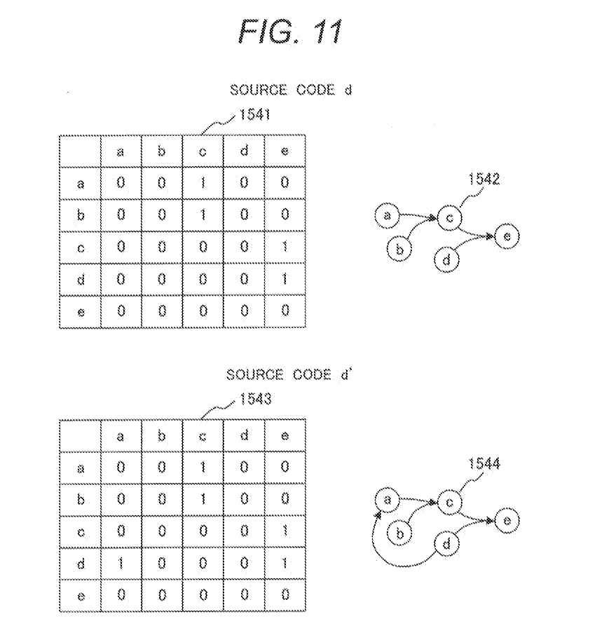

FIG. 11 is a diagram showing details of the data flow version data 154. A matrix 1541 is a diagram that shows a variable dependence relationship in the source code file 1521 of a certain version in tabular form. A data flow 1542 is a diagram that shows the variable dependence relationship in the source code file 1521 in graphical form. A matrix 1543 is a diagram that shows a variable dependence relationship in the source code file 1522 of another version in tabular form. A data flow 1544 is a diagram that shows the variable dependence relationship in the source code file 1522 in graphical form.

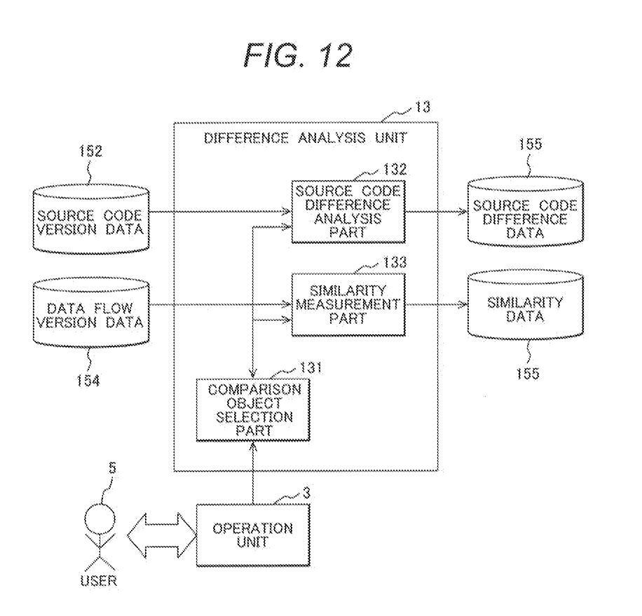

FIG. 12 is a diagram showing a detailed configuration of the difference analysis unit 13. The difference analysis unit 13 includes: the comparison object selection part 133 for selecting data information of the version of the source code indicating the comparison object, etc by the user 5 through the operation unit 3; a source code difference analysis part 131 for analyzing a difference between the source code versions; and a similarity measurement part 132 for measuring the similarity between the data flows. The difference analysis unit 13 inputs therein data information indicating the comparison object from the user 5 through, the operation unit 3, analyzes a difference between the source codes, outputs the source code difference data using the source code version data and the data flow version as inputs based on the data information of the comparison object, and at the same time, outputs the similarity data by measuring the similarity of the data flows.

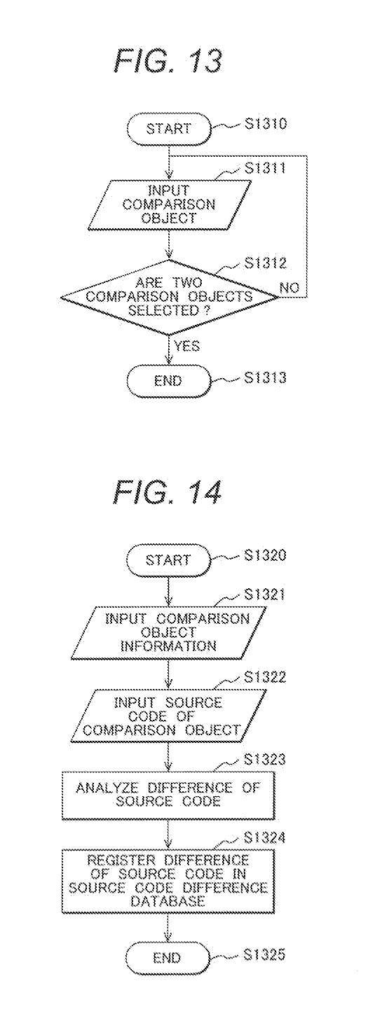

FIG. 13 is a diagram showing a detailed execution flow of the comparison object selection part 133. The processing begins from step S1310. At step S1311, information data of the comparison object is inputted from the user 5 through the operation unit 3. As the information data, version information and release information of rue source code are enumerated. At step S1312, it is judged whether two comparison objects inputted at step S1311 have been selected. When the two comparison objects have been selected (YES), the process proceeds to step S1313, where the processing is ended. When the two comparison objects have not been selected (NO), the process proceeds to step S1311, where the processing is continued. Thus, input error by the user, etc. can be prevented by further installing the processing like S1312.

FIG. 14 is a diagram showing a detailed execution flow of the source code difference analysis part 131. The processing begins from step S1320. At step S1321, it inputs comparison object information from the comparison object selection part 133. At step S1322, it inputs the source code of the comparison object from the source code version data 152 based on the comparison object information inputted at step S1321. At step S1323, it analyzes the difference of a source code which is the basis of the comparison and the source code of the comparison object inputted at step S1322. As analytic methods, techniques such as a diff command currently prepared as a shell command, for example, in UNIX (registered trademark) etc. and a comp command in MS-DOS (registered trademark) can be used. Thereby, a difference between source codes described in text etc. can be analyzed. At step S1324, the source code difference data analyzed from step S1323 is registered in the source code difference data 155 that is a database of source code difference. The difference data can be expressed by line number data of the source code, etc., for example. The processing is ended at step S1325.

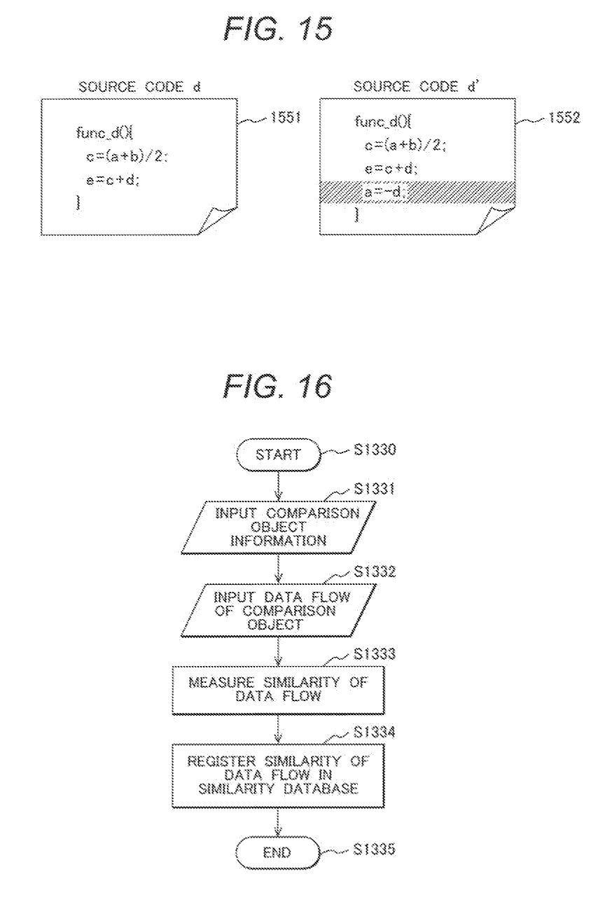

FIG. 15 is a diagram showing details of an example in which the source code difference data 155 is displayed in the source code of a new version. As a result of comparing a source code file 1551 and a source code file 1552 that are of old and new versions, it turns out that an update processing of updating the variable a in the source code file 1552 is a difference between the source code file 1551 and the source code file 1552.

FIG. 16 is a diagram showing a detailed execution flow of the similarity measurement part 132. The processing begins from step S1330. At step S1331, the comparison object information is inputted from the comparison object selection part 133. At step S1332, a data flow of the comparison object is inputted from the data flow version data 154 based on the comparison object information inputted at step S1331. At step S1333, the similarity of a data flow which is the basis of the comparison and the data flow of the comparison object inputted at step S1332 is measured. Here, although the similarity may be considered to include a correlation coefficient, a Hamming distance, centering resonance analysis, etc., similarity measurement that uses the correlation coefficient will be described later here. At step S1334, the similarity measured from step S1333 is registered in the similarity data 156 that is a database of similarity information. The processing is ended at step S1335.

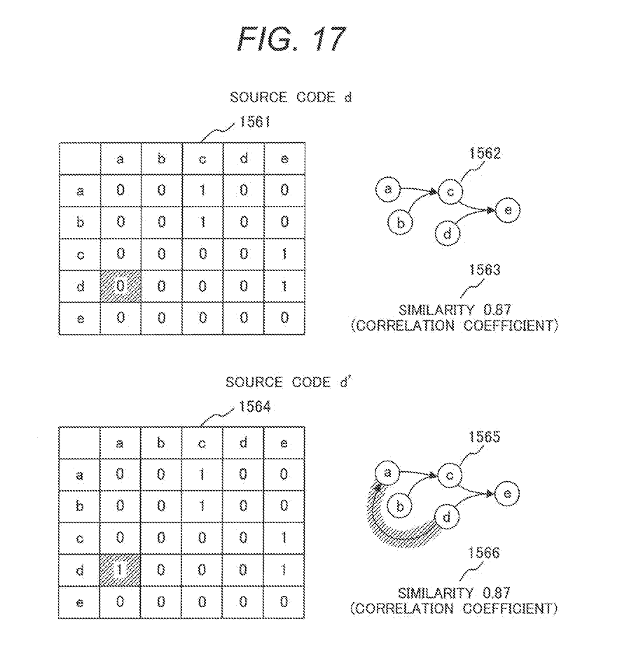

FIG. 17 is a diagram showing details of the similarity data 156. Comparing a matrix 1561 that expresses a variable dependence relationship in a source code version 152 in tabular form and a matrix 1564 that expresses a variable dependence relationship in a source code version 152 in tabular form, it turns out that values of (d, e) differ from each other, being 0 and 1. Comparing a data flow 1562 and a data flow 1565 each of which expresses the same content in graphical form, it turns out that a dependence relationship line toward from the variable d to the variable a is different. Obtaining the correlation coefficient that is a similarity of the data flow 1562 and the data flow 1565, it turns out to be 0.87. The correlation coefficient computed here is defined by r in the following formula.

$$r = \frac{{\sum }_{i = 1}^{n} ( {x}_{i 1} - {\overline{x}}_{1} ) ( {x}_{12} - {\overline{x}}_{2} )}{\sqrt{{\sum }_{i = 1}^{n} {( {x}_{i 1} - {\overline{x}}_{1} )}^{2} \sqrt{{\sum }_{i = 1}^{n} {( {x}_{i 2} - {\overline{x}}_{2} )}^{2}}}}$$

$$\overline{x} = \frac{1}{n} {\sum }_{i = 1}^{n} {x}_{i}$$

Here, xᵢ indicates remaining components of the matrices 1562 and 1564 each expressing the variable dependence relationship in tabular form with their diagonal components excluded. That is, xᵢ₁ and xᵢ₂ in this case can be written in the following forms, respectively.

xᵢ₁=(0,1,0, 0,0,1, 0,0,0, 0,0,1, 0,0,0, 1,0,0, 0, 0)

xᵢ₂=(0,1,0, 0,0,1, 0,0,0, 0,0,1, 1,0,0, 1,0,0, 0, 0)

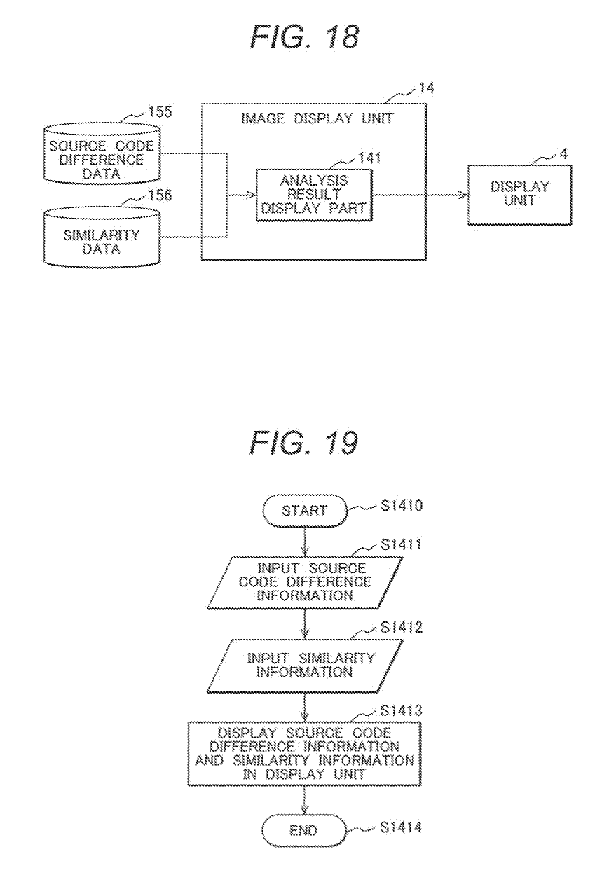

FIG. 18 is a diagram showing a detailed structure of the image display unit 14. The image display unit 14 has a difference data output part 141 for displaying the source code difference data 155 and the similarity data 156 in the display unit 4. The image display unit 14 inputs therein the source code difference data 155 and the similarity data 156 and outputs difference information of the source code and the similarity between the data flows to the display unit 4

FIG. 19 is a diagram showing a detailed execution flow of the difference data output part 141. The processing begins from step S1410. At step S1411, the source code difference information is inputted from the source code difference data 155. At step S1412, the similarity information of the data flow is inputted from the similarity data 156. At step S1413, the source code difference information and the similarity information that are inputted from step S1411 and step S1412 are outputted to the display unit 4. The processing is ended at step S1414.

Incidentally, the source code difference information and the similarity information may be presented to other computers and users through a medium of a network etc. without outputting them to the display unit 4.

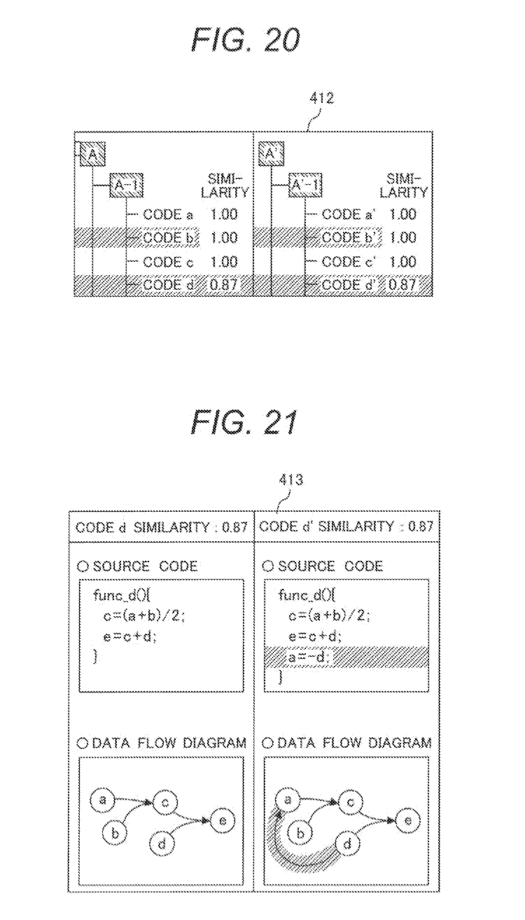

FIG. 20 is a diagram showing one example of an image display result of the image display unit 14. In this example, a result of comparing a directory A containing a folder A-1 that has source codes a, b, c, and d and a directory A containing a folder A′-1 that has source codes a′, b′, c′, and d′ is shown. In a display result 412, existence of pieces of difference information between the source codes b and b′ and between the source codes d and is highlighted. Moreover, it turns out that while the similarity between the source codes b and b is 1.00, the similarity between the source codes d and d′ is 0.87. This shows at a glance that a change of the variable dependence relationship does not exist between the source codes b and b′ among between the source codes b and b and between source codes d and d′, and there is a change of the variable dependence relationship between the source codes d and d′.

Incidentally, in this embodiment, although the difference analysis unit 13 includes both the source code difference analysis part 131 and the similarity measurement part 132, the source code difference analysis part 131 may be omitted. However, in this embodiment, since both of the difference between the source codes and the similarity between the data flows can be compared by including the source code difference analysis part 131, it is possible to differentiate and grasp a change of a formal description of mere source code and a change of description of the source code that will actually change the variable dependence relationship. In addition, by having the source code difference analysis part 131, a specific part where the change has occurred in the source code can be checked, and the change part can also be specified in a part finer than a file unit, for example, in information of the line number of the source code, etc.

FIG. 21 is a diagram showing one example of the image display result of the image display unit 14. In the image, the source code difference between the source codes d and d′, discrepancy of the data flow, and a value of the similarity 0.87 are displayed.

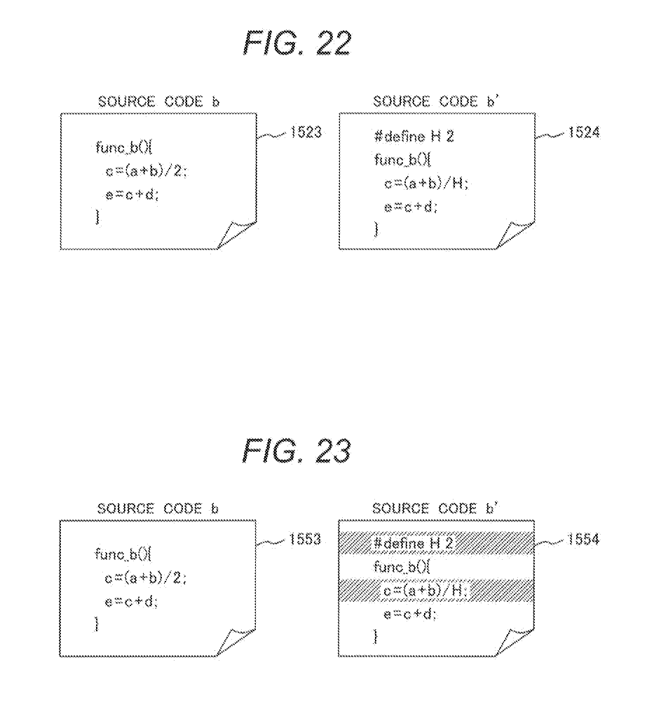

FIG. 22 is a diagram showing details of a source code b and a source code b in the source code version data 152. As shown in the diagram, the source code d′ differs from the source code d in a point that a macro H is used.

FIG. 23 is a diagram showing details of the source code difference data 155. In the source code d′, a place where the macro H is used is highlighted as a difference.

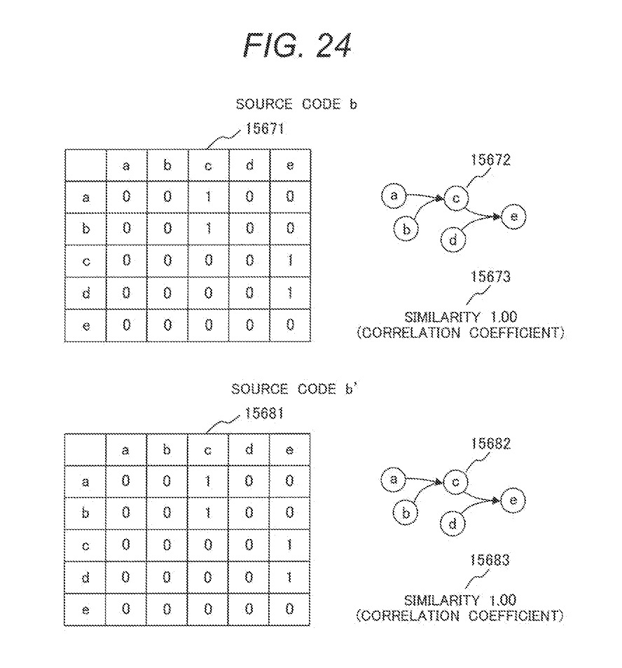

FIG. 24 is a diagram showing details of the similarity data 156. Since there exists no change between the source code b and the source code b′, a matrix 15671 and a matrix 15681 each of whose variable dependence relationships is expressed in tabular form have exactly the same values. Moreover, data flows 15672 and 15682 each of whose variable dependence relationships is expressed in graphical form also give the same result. Therefore, a correlation coefficient 15673 and a correlation coefficient 15683 each showing the similarity become 1.00.

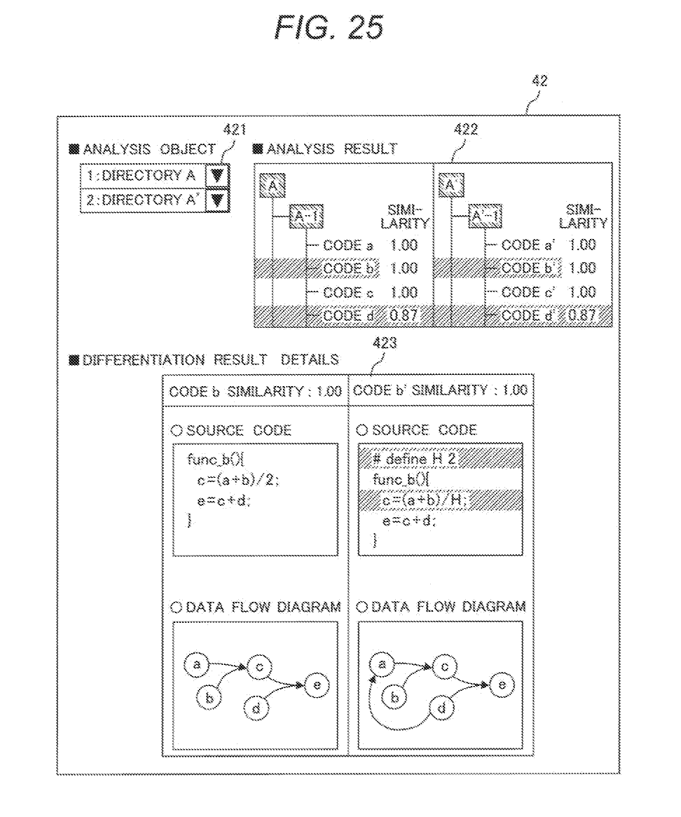

FIG. 25 is a diagram showing one example of the image display result of the image display unit 14. In this diagram, an analysis result of an analysis object 421 that was selected by the user 5 is displayed in window 422, and details of a differentiation result are displayed in window 423. This diagram shows at a glance that although the source codes b and b have a difference in the source code, the data flows indicating the variable dependence relations are equivalent and the similarity is 1.00.

Thus, according to this embodiment, since not only the difference between the source codes but also the similarity of the data flows are compared, it is possible to grasp whether there was actually any change in the variable dependence relationship, not a difference of only description between mere source codes. Thereby, specification of the substantial change part of the source code and an influence that the change part has on the surroundings substantially can be grasped.

### Example 2

Hereafter, another embodiment of the present invention will be explained focusing on a different point from Example 1.

In this embodiment, as the data flow data 153 and the data flow version data 154 that are registered in the configuration management DB, the source code analysis part 121 creates a data flow with a function designated as a node and a calling relationship between functions designated as a link. In this case, a situation that a function represented by a certain node is calling a function represented by another node is represented.

According to this embodiment, even in the case of a source code such that calling between functions is complicated, it becomes possible to easily specify the change part between versions of the source code, and to easily specify an area of influence that the change part has on the surroundings.

### Example 3

Hereafter, further another embodiment of the present invention will be explained focusing on a different point from the examples explained heretofore.

In this embodiment, from a source code installed in an embedded control device for controlling a control object such as an elevator, a vehicle, and construction machinery, a data flow is created by dividing it for each control period, and is registered in the each data base of the data flow data 153 and the data flow version data 154. In addition, the similarity between the graphical structures that were divided for respective control periods is measured. Processing of dividing the source code to each control period may be performed in the source code analysis part 121, or the source codes that were divided for respective control periods may have been inputted in the source code data 151 in advance.

The embedded control device, for example, an elevator control device, adopts a so-called data-driven type calculation model that activates a task in a constant period or by interruption, updates a control variable based on inputs of sensors such as a destination floor specifying button, a door safety sensor, etc., and controls actuators of a motor for door open and shut, a motor for driving a cage, etc. Moreover, multiple tasks are prepared in accordance with multiple kinds of control periods or interruptions. Then, control processing performed in each task often forms an original feedback loop, individually. Therefore, it is often the case where a reference relationship of data and a calling relationship of functions that accompany input from a sensor performed in each task, and operation and updating of the control variable complete by control processing that is performed within the same task. In addition, when only the source code related to processing that is performed at a certain control period is changed, a range of influence that the change part has on the surroundings is often within the source code related to the processing performed in the same control period.

In this embodiment, the data flow is created being divided for each control period or each content of interruption, and measurement of the similarity by the similarity measurement part 132 is performed.

According to this embodiment, since the measurement of she similarity is performed by dividing the graphical structure to each control period and an area of influence that the change part has on the surroundings can be predicted and limited in advance, it is possible to reduce an operation load given by the measurement of the similarity and to achieve simplification of the data that is presented to the user through the display unit 4. Especially in the case where a software scale is large-scale, it is useful to simplify the data and present it to the user in order to grasp an outline of the change part. Moreover, the change part can be specified in a task unit smaller than a file unit of the source code.

Incidentally, the control period mentioned here is not limited to a fixed period such as an interval, of 10 ms, and may be, for example, a period of synchronization of the number of revolutions of an engine that is performed in synchronization with the number of revolutions of a vehicular engine, and the like.

### Example 4

Hereafter, further another embodiment of the present invention will be explained centering on a different point from the examples explained heretofore.

In this embodiment, processing of deciding an important node among all nodes based on the size of the dependence relationship of the variable is performed. The source code analysis part 121 decides a node whose reference relationship of data is large in number to be an important node when creating the data flow, and registers a data flow obtained by thinning out nodes except the important node and unnecessary links in the data flow data 153 and the data flow version data 154.

Here, as one example of a size of the reference relationship of data, a node that represents the variable a and a node that represents the variable c shown in the data flow diagram of FIG. 1 will be explained. Since the variable c is decided based on the variables a and b and is also referred to by the variable e, three reference relationships of data exist for the variable c. On the other hand, since the variable a is referred to only by the variable c, only one reference relationship of data exists. Thus, the size of the reference relationship of data can be judged.

Incidentally, the important node may be decided based on statistical processing that sees the size of the data reference relationship from the whole of the source code, or may be decided based on a predetermined threshold.

According to this embodiment, the measurement of the similarity by the similarity measurement part 132 is performed on the data flow represented only with the important nodes, it is possible to reduce an arithmetic load given by the measurement of the similarity, and to achieve simplification of the data that is presented to the user through the display unit 4.

In the foregoing, although the embodiments of the present invention were explained, each of the inventions indicated by these embodiments shall not be grasped as an independent invention, they can be carried out being combined appropriately, and it is obvious that such a combination thereof does not require trail and error for a person skilled in the art.

### REFERENCE SIGNS LIST

1 . . . Software analysis system
2 . . . Computer
3 . . . Control unit
4 . . . Display unit
5 . . . User
11 . . . Source code management unit.
12 . . . Data flow management unit.
13 . . . Difference analysis unit
14 . . . image display unit
15 . . . Configuration management DE
111 . . . Source code registration part
121 . . . Source code analysis part
122 . . . Data flow registration part
131 . . . Source code difference analysis part
132 . . . Similarity measurement part
133 . . . Comparison object selection part
141 . . . Difference data output part
151 . . . Source code data
152 . . . Source code version data
153 . . . Data flow data
154 . . . Data flow version data
155 . . . Source code difference data

1.-10. (canceled)

11. A computer-readable medium storing code for analysis of a plurality of source codes inputted into a computer and for specifying a change part of the source code, wherein the code, when executed by a software analysis system, causes the software analysis system to:
extract a dependence relationship of a global variable from each of at least two source codes among the plurality of source codes;
create a graphical structure that contains a node representing the global variable and a link representing a substitution relationship among the global variables;
measure a similarity between the graphical structures corresponding to the two respective source codes; and
output the similarity measure outside of the computer.

12. The computer-readable medium of claim 11,
wherein the similarity is a Hamming distance, a correlation coefficient, or centering resonance.

13. The computer-readable medium of claim 11,
wherein the node represents a function and the link represents a calling relationship between the functions.

14. The computer-readable medium of claim 11,
wherein the similarity is measured on a graphical structure comprised of important nodes that are decided statistically from sizes of the reference relationships of the nodes.

15. The computer-readable medium of claim 11,
wherein the similarity is measured on a graphical structure that is comprised for each control period of the source code.

16. The computer-readable medium of claim 11,
wherein an image of the measured similarity is displayed.

17. The computer-readable medium of claim 11,
wherein the graphical structure is displayed together with the measured similarity.

18. The computer-readable medium of claim 11,
wherein a difference between two source codes is analyzed and outputted to the outside of the computer.

19. The computer-readable medium of claim 11, wherein the software analysis system:
makes the computer extract a dependence relationship of a variable or a function from an inputted source code and makes the computer create a graphical structure comprised of nodes and links; and
makes the computer measure a similarity of two graphical structures.

20. A method for analyzing a plurality of source codes inputted into a computer and specifying a change part of the source code, the method comprising:
extracting, by a software analysis system computer, a dependence relationship of a global variable from each of at least two source codes among the plurality of source codes;
creating, by the software analysis system computer, a graphical structure that contains a node representing the global variable and a link representing a substitution relationship among the global variables;
measuring, by the software analysis system computer, a similarity between the graphical structures corresponding to the two respective source codes; and
outputting, by the software analysis system computer, the similarity measure outside of the software analysis system computer.

21. The method of claim 20, wherein the similarity is a Hamming distance, a correlation coefficient, or centering resonance.

22. The method of claim 20 wherein the node represents a function and the link represents a calling relationship between the functions.

23. The method of claim 20 wherein the similarity is measured on a graphical structure comprised of important nodes that are decided statistically from sizes of the reference relationships of the nodes.

24. The method of claim 20 wherein the similarity is measured on a graphical structure that is comprised for each control period of the source code.

25. The method of claim 20 wherein an image of the measured similarity is displayed.

26. The method of claim 20 wherein the graphical structure is displayed together with the measured similarity.

27. The method of claim 20 wherein a difference between two source codes is analyzed and outputted to the outside of the computer.

28. The method of claim 20, further comprising:
making the computer extract a dependence relationship of a variable or a function from an inputted source code and making the computer create a graphical structure comprised of nodes and links; and
making the computer measure a similarity of two graphical structures.
